(19) United States
(12) Patent Application Publication
(10) Pub. No.: US 2003/0112269 A1
(43) Pub. Date: Jun. 19, 2003

(54) Configurable graphical element for monitoring dynamic properties of a resource coupled to a computing environment

(75) Inventors: James Lentz, Austin, TX (US); Jack A. Alford JR., Austin, TX (US); Kenneth R. Banning, Austin, TX (US)

Correspondence Address: Edmond A. DeFrank, 20145 Via Medici, Northridge, CA, 91326, US

(73) Assignee: International Business Machines Corporation, Armonk, NY

(21) Appl. No.: 10/015,242

(22) Filed: Dec. 17, 2001

(51) Int. Cl. G09G 5/00

(52) U.S. Cl. 345/738

(57) ABSTRACT

The present invention is embodied in a configurable graphical element for tracking and monitoring dynamic properties of resources and events coupled to a computing environment. In general, the present invention includes an interactive configurable graphical element with a software control that monitors resources and events. The graphical element interactivity provides the monitored information to a user with a status display area having configurable threshold trigger points and can also include one or more rearm trigger points. The user configurable trigger points are located within one end of the status display area and include at least one user configurable threshold point and at least one rearm set point. The monitoring display and configuration functions are combined in a single graphical element for reducing complexity and easing the use of monitoring applications.

### BACKGROUND OF THE INVENTION

1. Field of the Invention.

The present invention relates in general to a configurable device for tracking and monitoring dynamic properties of resources and events coupled to a computing environment. In particular, the present invention relates to an interactive configurable graphical element with a software control that monitors resources and events. The graphical element provides interactivity of the monitored information to a user with configurable threshold and rearm trigger points and a status display area.

2. Related Art.

Computers are a regular part of the everyday life of many people. Computers are typically used in one's home as well as one's business or work place. A computer monitor is one of the main interfaces used to enable a person to interact with the computer. The computer monitor has a display screen for displaying information, usually in graphical format, to the user. Input devices, such as a mouse and a keyboard are also devices that are used to interface a user with the computer.

The junction between a user and the computer is commonly called a user interface. A user interface is typically in the form of a set of commands and menus through which a user communicates with the computer. A command-driven interface is one in which a user enters commands. A menu-driven interface is one in which a user selects command choices from various menus displayed on the screen. The user interface is one of the most important parts in a computer system because it determines how easily a user can make the program do what the user wants. Graphical user interfaces (GUIs) that use windows, icons, and pop-up menus have become standard on personal computers.

User interfaces are typically used in computing environments for easy navigation, control, display of status information, etc. of software programs and applications of a given operating system. One type of user control in computing environments includes resource and event monitoring and tracking of internal resources and events. In one example, a computing environment can be used to monitor external resources or events, such as medical data or manufacturing data. These resources and events need to be monitored and tracked by the user. If the data falls below a threshold or emergency level, the computing environment needs to make the user aware in an efficient manner to avoid detrimental results.

In another example, internal computing resources need to be monitored by an administrative user. In typical computing environments, the resources can fall below ideal and working threshold levels, depending on usage. When the resources fall below these threshold levels, the computing environment can become unstable. This can cause severe problems in not only single user environments, but also in multi-user networking environments.

A common way of handling the visual monitoring of resources and the setting of thresholds for alarms and alerts is to supply two separate user interfaces. One is a display user interface that shows status, in either graphical or tabular form. The second is a configuration user interface, which uses conventional user interface controls such as text boxes, spin buttons, or slider controls to set the value of alarm or alert thresholds. In this approach, the setting of threshold values and viewing of current status are physically separated, either in separate windows or in different areas of the same windows, and use separate GUI control elements for viewing status and setting threshold values.

However, this approach has at least two problems that detract from its ease of use. First, in computer user interfaces, the amount of screen space required to display information and to handle user interactions such as configuration operations is an important consideration in ease of use. Screen space is used for both displaying status and configuring threshold settings. This leaves less space for other important elements, such as other status displays. Second, the physical distance between GUI elements that are frequently accessed together is important for ease of use. If such GUI elements are physically separated, it will be not as easy for users to understand that they are related and it will take more time to access them in sequence.

The problem is more severe if the threshold configuration control elements are in a separate window from the status display because the user may have to perform a number of operations to access the configuration control elements. For example, if a user decides that a threshold is to be modified while the user is viewing a status display, the user would first need to click on a menu choice or push button to cause the configuration window to appear, then click on one or more controls to change the threshold values. Finally, the user would have to click on a button to dismiss the configuration window and submit the changes. If the configuration controls are physically separate from the status display but still in the same window, the user would still need to look away from the status display and move a pointing device to the configuration area, before making changes to the configuration settings. As such, the user has to perform numerous and cumbersome steps.

Hence, current resource tracking and event monitoring devices do not provide enough intuitive user interactivity or configurability to help keep a user informed at all times of resource levels or detrimental events that can occur in an easily understood manner. Namely, current systems use configuration/setting functions that are separate from display/monitoring functions and controls that are not intuitive, which is inefficient. If the user had a configurable graphical device that interactively kept them aware of the resources and events in a single control device, they could possibly avoid low resource levels and detrimental events in an efficient manner. The present invention recognizes and solves these problems.

### SUMMARY OF THE INVENTION

To overcome the limitations described above, and to overcome other limitations that will become apparent upon reading and understanding the present specification, the present invention is embodied in a configurable graphical element for tracking and monitoring dynamic properties of resources and events coupled to a computing environment.

In general, the present invention includes an interactive configurable graphical element with a software control that monitors resources and events. The graphical element provides interactivity of the monitored information to a user with a status display area and has configurable trigger points comprised of threshold trigger points. Also, the user configurable trigger points can include zero or more rearm trigger points. The user configurable trigger points are located anywhere along the longer axis of the status display area.

The monitoring display and configuration functions are combined in a single graphical element for reducing complexity and easing the use of monitoring applications. Thus, the present invention gives the user the ability to view the value being measured (by the length of a status bar), view the value of the triggers (by the position of the triggers), and set the position of the triggers all from the same graphical element.

The status display area preferably includes a status indicator bar that communicates to the user status information relating to the resources or event being monitored. In one embodiment, the status indicator bar is slightly smaller than the display area and is positioned inside, concentric with a larger rectangle of the display. In one embodiment, the status bar is configured as a rectangular visually-coded area (such as color-coded) to visually and demonstratively represent resource conditions. For example, the color white would mean the monitored values are within predefined limits and the color red would mean that a threshold value was exceeded. A numerical legend is located on the long axis, which represents a total range of values.

The threshold triggers represent specific user predefined threshold values within the range of values indicated by the status indicator bar. In some embodiments, multiple thresholds may be used in the same status display area. For example, successive low level, mid level, and high level thresholds could be used in the same status display. When the low level threshold is exceeded, an alert is initiated. When the mid level threshold is exceeded, an alert is initiated with a suggested action with user confirmation. When the high level threshold is exceeded, an alert is initiated and a predefined action takes place automatically, without user confirmation.

At least one rearm trigger (there can be one threshold, or each threshold can have its own rearm trigger) is a user predefined rearm set point for rearming the alert functions after a threshold value is tripped to avoid continuous and unwanted alerts within a value limit. In other words, when a threshold trigger is tripped, the alert functions are disabled and not reset and rearmed until the resource or event value falls below the rearm trigger set point value. This prevents the alert from being continuously set off as resource values fluctuate slightly below and above the threshold value over a short time period. This continuous alarm can create an annoyance that is limited by the rearm trigger.

Other aspects and advantages of the present invention as well as a more complete understanding thereof will become apparent from the following detailed description, taken in conjunction with the accompanying drawings, illustrating by way of example the principles of the invention. Moreover, it is intended that the scope of the invention be limited by the claims and not by the preceding summary or the following detailed description.

### BRIEF DESCRIPTION OF THE DRAWINGS

Referring now to the drawings in which like reference numbers represent corresponding parts throughout:

FIG. 1 illustrates a conventional hardware configuration for use with the present invention.

FIG. 2 is a block diagram illustrating an overview of the present invention.

FIG. 3A is a diagram illustrating a working example of a first embodiment of the present invention.

FIG. 3B is a diagram illustrating a working example of a second embodiment of the present invention.

FIG. 4 is an operational diagram of the working example of FIG. 3A and FIG. 3B.

FIGS. 5A-5E illustrate a working example of FIG. 4 showing details of the graphical element.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. Exemplary Environment

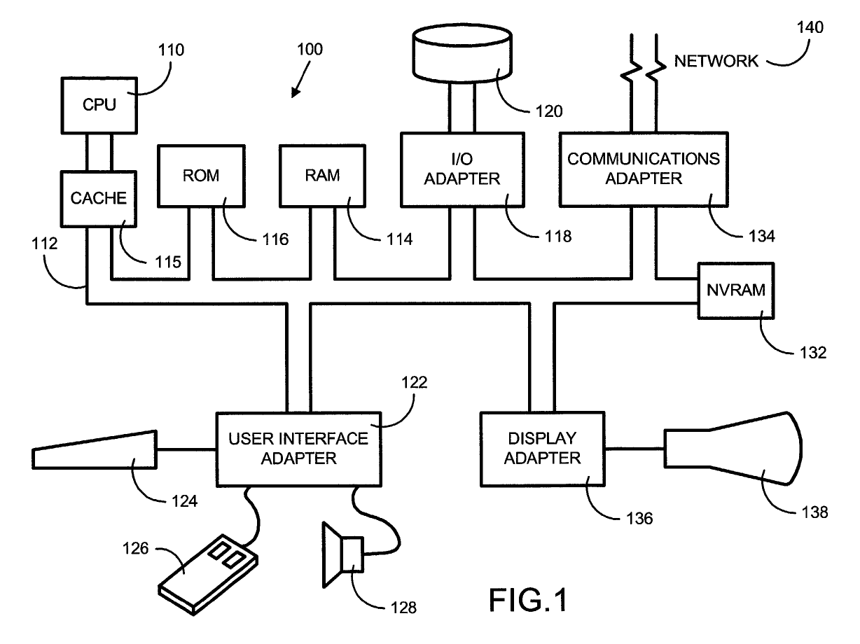

The preferred embodiments may be practiced in any suitable hardware configuration that uses a networked connection, such as computing system 100 illustrated in FIG. 1 or alternatively, in a laptop or notepad computing system. Computing system 100 includes any suitable central processing unit 110, such as a standard microprocessor, and any number of other objects interconnected via system bus 112.

For purposes of illustration, computing system 100 includes memory, such as read only memory (ROM) 116, random access memory (RAM) 114, Non-Volatile Random Access Memory (NVRAM) 132 and peripheral memory devices (e.g., disk or tape drives 120) connected to system bus 112 via I/O adapter 118. The cache 115 is a special section of random access memory. Computing system 100 further includes a display adapter 136 for connecting system bus 112 to a conventional display device 138. Also, user interface adapter 122 could connect system bus 112 to other user controls, such as keyboard 124, speaker 128, mouse 126, and a touch pad (not shown). In addition, the system 100 can be connected via a communications adapter 134 to a network 140.

One skilled in the art readily recognizes how conventional computers and computer programs operate, how conventional input device drivers communicate with an operating system, and how a user conventionally utilizes input devices to initiate the manipulation of objects in a graphical user interface.

A graphical user interface (GUI) and operating system (OS) of the preferred embodiment reside within a computer-readable media and contain device drivers that allow one or more users to initiate the manipulation of displayed object icons and text, on a display device. Any suitable computer-readable media may retain the GUI and OS, such as ROM 116, RAM 114, disk and/or tape drive 120 (e.g., magnetic tape, magnetic diskette, CD-ROM, optical disk, or other suitable storage media).

In the preferred embodiment, the GUI may be viewed as being incorporated and embedded within the operating system. Alternatively, any suitable operating system or desktop environment could be utilized.

II. Component Overview

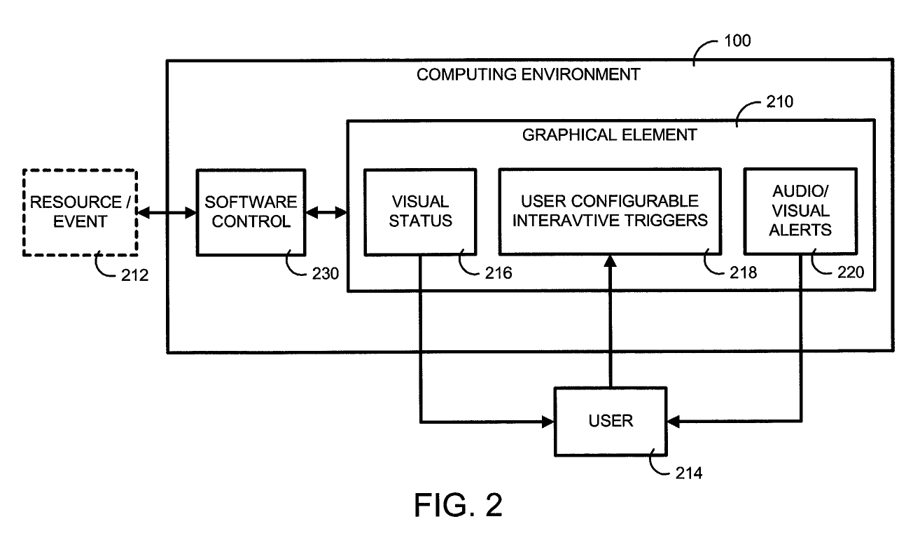

FIG. 2 is a block diagram illustrating an overview of the present invention. In general, the present invention includes an interactive and configurable graphical element 210 for tracking and monitoring dynamic properties of resources and/or events 212 coupled to the computing environment 100. The resource and/or event 212 is shown with dotted lines to indicate that it can be external or internal to the computing environment 100.

The configurable graphical element 210 is displayed on monitor 138 of FIG. 1 and displays dynamic properties of the resources 212 coupled to the computing environment 100. The graphical element 210 provides interactivity of the tracked information to a user 214 with a visual status display area 216, configurable threshold and rearm trigger points 218 and audible and visual alerts 220. A software control module 230 coupled to the resource 212 is included to gather, process and reformat raw data from the resource 212 into a format usable by the graphical element 210.

The software control module 230 is an active program that is continuously coupled to the resources 212 for tracking properties associated with the resources 212. The software control module 230 is also coupled to the graphical element 210 for sending data to be displayed on the graphical element 210. The data from the resources 212 is processed in real time by the software control module 230 and immediately sent to the graphical element 210 for immediate reporting and tracking management by the user 214. Depending on the computing environment, the software control module 230 can be implemented as a program or similar device that is programmed in any suitable programming language, such as C, C++, Java, or the like.

III. Details of the Components and Operation

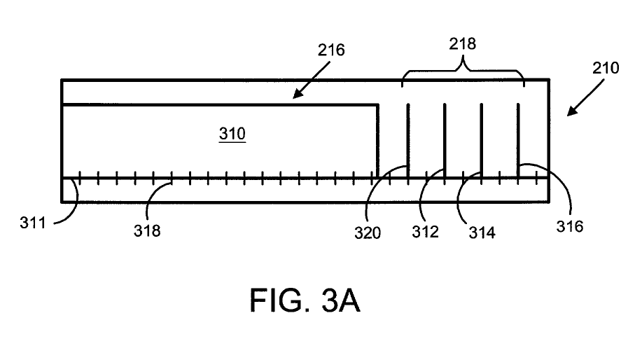

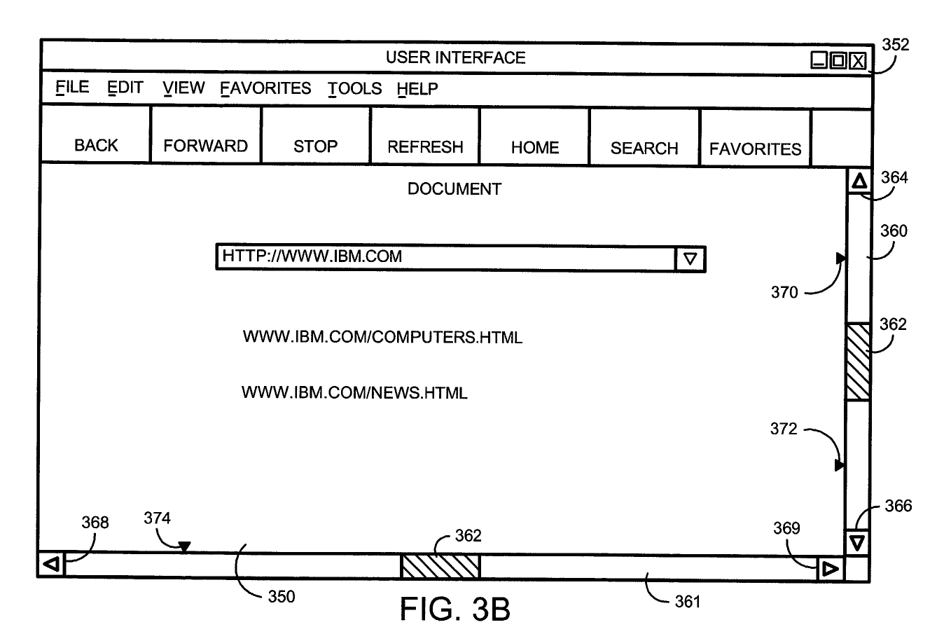

FIG. 3A is a diagram illustrating an exemplary graphical element of a first embodiment of the present invention. Referring to FIG. 2 along with FIG. 3A, the status display area 216 preferably includes a status indicator bar 310 that communicates to the user 214 status information relating to the resources 212 being monitored. The status indicator bar 310 is tied to monitored properties of the resource 212 and fluctuates along a long axis scale 311 of the display area 216 to display these monitored properties. The scale 311 is representative of the property values of the resource 212 and the length of the status bar 310 displays current property values of the resource 212. In FIG. 3A, tick marks 318 are located on the long axis scale 311 of the status display area 216 to track numerical values of the resource 212.

In addition, the status bar 310 can include demonstrative indicia, such a color-coding scheme, to represent critical values of the resource 212. In one embodiment, the status bar 310 automatically becomes a red color to demonstratively alert the user 214 to a critical value, namely that a predefined threshold value was exceeded. Also, the status bar 310 flashes and blinks a red color as part of the alert in another embodiment.

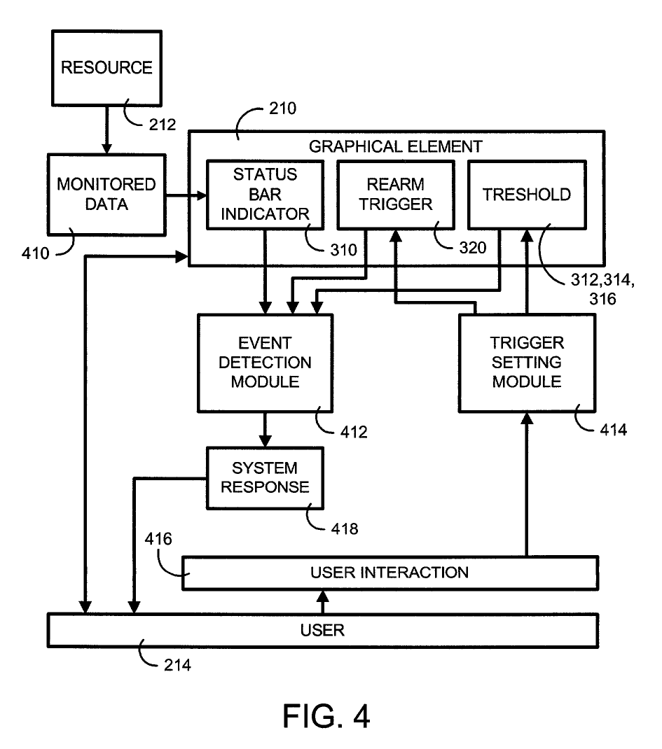

The configurable triggers 218 include one or more threshold triggers 312, 314, 316 which represent specific user defined threshold values within a range of values covered by the graphical element 210 and at least one rearm trigger 320. In this embodiment, the threshold values include successive low level 312, mid level 314 and high level 316 thresholds. Each threshold trigger 312, 314, 316 is associated with an event that occurs when the predefined threshold is exceeded (described below with reference to FIG. 4) by the status bar 310 and each can have its own associated rearm trigger. At least one rearm trigger 320 is a user predefined rearm set point for rearming the monitoring and alert functions after a threshold value is tripped at the trigger. This avoids continuous and unwanted alerts within a value limit.

FIG. 3B is a diagram illustrating a working example of a second embodiment of the present invention. Referring to FIG. 2 along with FIG. 3B, in the embodiment, a user 214 can navigate through pages of a document 350 of a user interface 352 by utilizing one or more scroll bars 360. The scroll bar 360 can appear on the side or bottom of an area of the document 350 and provides the user 214 slidable navigation and viewing control of the pages within the document 350. The length of the scroll bar 360 represents the entire document, which makes it easy for the user 214 to graphically move quickly to locations within the document 350.

The side scroll bar 360 includes a scroll box 362, end points 364, 366 and trigger points 370, 372, 374. The user 214 can move a respective scroll box 362 along the side scroll bar 360 or bottom scroll bar 361 for navigating from one page to another page within the document 350. The end points 364, 366, 368, 369 represent the top, bottom, left and right portions of the digital document, respectively. The trigger points 370, 372, 374 represent reference points within the digital document that are predefined by the user 214 or the application and located directly on respective scroll bars 360, 361. The trigger points 370, 372, 374 function to either alert, stop or pause the movement of the scroll box 362 as the user 214 moves it along the respective scroll bars 360, 361.

In operation, a user 214 can move to any part of the document 350 by dragging the scroll box 362 to a corresponding part of the respective scroll bars 360, 361. Plural trigger set points 370, 372, 374 can be predefined by the user 214 as bookmarks, page marks or reference points to indicate points of interest within the document 350. When one of the trigger points is reached, an auditory or visual signal can be initiated to alert the user 214 of a predefined point of interest in the document 350. Also, the movement of the scroll box 362 could be suspended. Alternatively, if an overt action by the user 214 was required, scrolling could be stopped. The system would allow the triggers 370, 372, 374 to be adjusted, disabled, re-enabled or deleted according to the desires of the user 214. Different behaviors could be preprogrammed into the triggers in any suitable manner. As one example, clicking a threshold trigger with a mouse could be used to disable the threshold trigger (indicated by latching the threshold trigger in a visually down position on the user interface).

In addition, the status of a trigger can be visually displayed to the user. For example, when a threshold trigger is tripped, the trigger itself could change visually (using a color scheme, e.g. turn to a grey color from an originally non-grey color) to indicate that it will be temporarily disabled until the rearm trigger is tripped. Clicking or double clicking on either kind of trigger would change the trigger's state between the enabled and disabled states. Also, the enablement or disablement status of a trigger could be visually coded, (for example, the color black to show enabled, and the color grey to show disabled). This allows visual indication of trigger status and enablement and disablement of triggers.

FIG. 4 illustrates a block diagram of a working example in a computing environment of the present invention. In operation, referring to FIGS. 2 and 4 along with FIGS. 3A-3B, monitored data 410 of the resource 212 drives the position and/or size of the status bar 310. An event detection module 412 compares values represented in the status bar 310 and the rearm trigger 320 and the threshold triggers 312, 314, 316. A trigger setting module 414 is configured by user interaction 416 to predefine and set the trigger points of the triggers 312, 314, 316, 320.

When tracked properties of the monitored data 410 equals the value of either the rearm trigger 320 or the threshold triggers 312, 314, 316, a predefined system response is generated by a system response module 418. The system response can be any suitable response to alert the user 214 of the values, including, but not limited to an e-mail notification, a pop-up warning message box, or a visual change in the appearance of the status 310, such as changing the color of the status bar 310 to red or yellow to signify an alert. In the example of FIG. 3B, a document scrolling system, the system response could be a temporary change of the user interaction 416 with the scroll bar 360 such as a temporarily halting its movement or popping an alert box in a small window.

In another embodiment, with reference to FIG. 3A, when a low level threshold 312 is exceeded, an alert is initiated by the system response module 418. When the mid level threshold 314 is exceeded, an alert is initiated by the system response module 418 with a suggested action with user 214 confirmation. The suggested action can be a suggestion to reduce resources in other areas for alleviating stress on the monitored resource 212 and requests user interaction 416. When the high level threshold 316 is exceeded, an alert is initiated by the system response module 414 and a predefined action takes place automatically, without user 212 confirmation. The predefined action can be an action that automatically reduces resources in other areas for alleviating stress on the monitored resource 212.

If a value fluctuates near the threshold value, an alert notification would occur frequently. A repeated notification may be contra-indicated, therefore a rearm trigger 320 can be used. As an example, when a threshold trigger is tripped, for example trigger 312, monitoring and alert functions are disabled and not reset and rearmed until the monitored value of the resource falls below the rearm trigger set point value. This prevents the alert from being continuously set off as resource values fluctuate slightly below and above the threshold value over a short time period. This continuous alarm can create an annoyance that is limited by the rearm trigger 320.

The trigger setting module 414 allows the user 214 to create trigger points at predefined locations within the status bar 310. Dragable slider knobs, drop down menus, shortcut functions enabled by the user interface or pop-up menus could be used to set the trigger points 320, 312, 314, 316. In one embodiment, the trigger setting module 414 is integrated with user interface menus of an application associated with the resource 212. In another embodiment, the trigger setting module 414 is controlled by the dragable slider knobs, drop down menus, shortcut functions enabled by the user interface or pop-up menus to allow real-time graphical interaction.

For example, the values are set in some other part of the user interface, such as a dialog box accessed by a drop down menu. Namely, direct entry of new trigger values could be accomplished by a popup text entry field. In particular, the user would click on the trigger and an entry field would appear near the trigger. The user could then enter a new trigger value numerically, press the ENTER key, and the trigger set point would move to the position indicated by this new value. This method also allows the user to make changes to the settings without the need to go to some other user interface control or menu.

Also, an application of the computing environment 100 can create on its own the trigger set points as a programmable intelligent decision based on the known ideal operating properties of the resource 212. Namely, a datum is determined by the application to be a point of threshold, based on a priori knowledge, or based on gathered information from the user.

For example, a priori knowledge base would be a knowledge base of typical values or indicia that represent values or data in a document, such as the value 1000 degrees Celsius in monitoring a manufacturing process. An example of gathered information from the user could be to include the speed of traffic in a volume of traffic flow equation where the result is dynamic based on supplementary information. The application can infer the threshold value and its importance based on the user interaction 416 with the application.

IV. Working Example

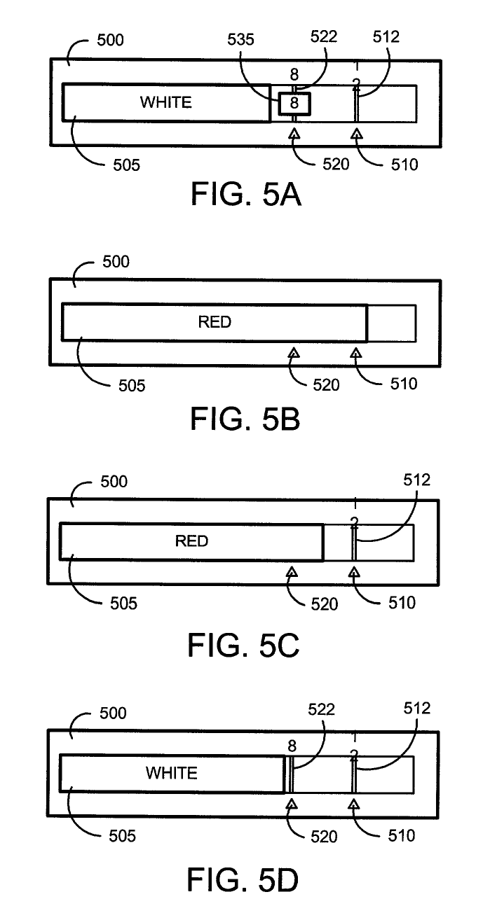

FIGS. 5A-5D illustrate a working example of FIG. 4 showing details of a graphical element 500. In this example, for illustrative purposes only, status bar 505 with one threshold trigger 510 (similar to trigger 316 of FIG. 3A) and one rearm trigger 520 (similar to trigger 320 of FIG. 3A) is shown. Referring to FIGS. 2 and 3A along with FIGS. 5A-5D, the user 214 can change the rearm 522 and threshold 512 values of the monitored resource 212 by selecting an arrowhead or marker 510, 520 of the graphical element 500 associated with the particular trigger. Moving the respective trigger to the left will lower values and moving it to the right increases values. The graphical element 500 can have the numeric value of the trigger 522 displayed in a value box 535 while the user has a marker selected.

As shown in FIG. 5A, marker 510 is associated with a threshold trigger point and marker 520 is associated with a rearm trigger point. In one embodiment, the user 214 can click on a marker 520 causing a pop-up menu or box 535 to appear near the marker 510 with the current value. The pop-up box 535 allows the user 214 to manually type a value in the pop-up box 535. As an example, trigger 522 is initially set at value 8 with popup boxes present. The user can then select trigger 522 by clicking on marker button 520 and a popup text entry box appears, overlaying trigger indicator 522, which is pre-filled with the value ‘8’ (because that is the current value of the trigger). Next, the user can type a new value, ‘10’ in the popup text entry box and presses the ENTER key. The popup box will then disappear and the trigger 522 and marker button move to the position indicated by the value 10 (i.e. it would move to the right 2 increments).

In this example, threshold trigger 510 is set at a value of 12 units and rearm trigger 520 is set at a value of 8 units. As the resource 212 is monitored, status bar 530 fluctuates between zero units to a maximum value, preferably a certain percentage above the predefined threshold value represented by threshold trigger 510. As shown in FIG. 5A, status bar 530 is color-coded with a white color when fluctuating below the threshold trigger 510. But when a value of the resource exceeds a value represented by the threshold trigger 510, the color of the status bar 530 changes to a red color, as shown in FIG. 5B and alerts and alarms discussed above are initiated. However, as shown in FIG. 5C, the status bar 530 remains red until the value of the resource 212 drops below the rearm trigger 520, as shown in FIG. 5D, where it is shown to change to white after the resource values falls below the rearm trigger 520.

The status bar remains red even if the value of the resource 212 drops below the threshold trigger 510. This is because, as discussed above, the rearm trigger 520 is used for rearming the alert functions after the threshold value is tripped to avoid continuous and unwanted alerts within a value limit. In other words, when the threshold trigger 510 is tripped, the alert functions are disabled and not reset and rearmed until the resource 212 falls below the rearm trigger 520. This prevents the alert from being continuously set off as resource values fluctuate near and slightly below and above the threshold 510 over a period of time right after the threshold trigger 510 is tripped. A continuous alarm can create an annoyance, which is limited by the rearm trigger 520.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method using a computer-readable medium having computer-executable instructions for tracking dynamic properties of a resource, the method comprising:
configuring plural predefined reference values of interest associated with the resource with an interactive graphical trigger; and
performing a predefined action when a value of the resource matches one of the reference values of interest.

2. The method of claim 1, further comprising configuring at least one predefined rearm value associated with the reference values of interest with an interactive graphical rearm trigger.

3. The method of claim 1, further comprising using a graphical user interface as the interface for displaying and allowing configuration of the interactive triggers.

4. The method of claim 1, further comprising providing at least one of auditory or visual feedback alert with real time user interaction as the predefined action.

5. The method of claim 1, further comprising displaying visually coded indicia associated with predefined reference values of interest.

6. The method of claim 1, further comprising displaying visually coded indicia associated with at least one of trigger status, enablement and disablement of the triggers.

7. The method of claim 1, wherein the interactive graphical triggers are threshold points representative of critical values defined by a user.

8. The method of claim 1, further comprising displaying the tracking with a display bar that has at least one of a drop down menu, a pop-up window or a shortcut function for enabling configuration of the graphical triggers.

9. In a computer system having a memory storage area and a graphical user interface, a method for tracking resources coupled to the computer system, the method comprising:
configuring threshold trigger points that reference critical values of interest of the resource;
configuring rearm trigger points that reference reset values of interest of the resource; and
alerting a user when a value of the resource exceeds the configured referenced critical value of interest.

10. The method of claim 9, wherein the trigger points are pre-configured by the user.

11. The method of claim 9, wherein the trigger points are pre-configured by the computer system.

12. The method of claim 9, further comprising providing at least one of auditory or visual feedback with real time user interaction as the alert.

13. The method of claim 9, wherein the alert includes performing a predefined action of at least one of suspension, cessation, adjustment, disablement, re-enablement, or deletion of events related to the resource.

14. A user interface of a computer system with a graphical display element for tracking dynamic properties of a resource, the graphical display element comprising:
plural interactive triggers corresponding to plural pre-configured reference values of interest associated with the resource; and
a module that performs a predefined action when a value of the resource matches one of the reference values of interest.

15. The graphical element of claim 14, further comprising at least one predefined rearm trigger corresponding with a rearm value that is associated with the reference values of interest.

16. The graphical element of claim 14, further comprising a status display bar that displays resource values and allows user configuration of the interactive triggers.

17. The graphical element of claim 16, wherein the status bar displays visually coded indicia associated with the predefined reference values of interest.

18. The graphical element of claim 14, wherein the predefined action includes at least one of auditory or visual feedback alert having real time user interaction.

19. The graphical element of claim 14, wherein a portion of the interactive graphical triggers are threshold points representative of critical values defined by a user.

20. The graphical element of claim 14, further comprising a display bar that has is at least one of a drop down menu, a pop-up window or a shortcut function for enabling configuration of the interactive triggers.
